(19) United States
(12) Patent Application Publication
(10) Pub. No.: US 2012/0158419 A1
(43) Pub. Date: Jun. 21, 2012

(54) HEALTHCARE PROVIDER HYGIENE COMPLIANCE MONITORING SYSTEM AND METHOD

(75) Inventor: Sridhar Nuthi, Sussex, WI (US)

(73) Assignee: GENERAL ELECTRIC COMPANY, Schenectady, NY (US)

(21) Appl. No.: 12/970,491

(22) Filed: Dec. 16, 2010

(51) Int. Cl. G06Q 50/00; G06Q 10/00

(52) U.S. Cl. 705/2

(57) ABSTRACT

In one embodiment, a method for monitoring hygienic compliance in a medical institution includes detecting presence of a healthcare provider in a patient area and identifying the healthcare provider to produce provider identification data. The monitoring method also includes detecting usage of a cleansing medium by the healthcare provider to produce usage data. The method includes transmitting the healthcare provider identification data and the usage data to an institutional information system. The monitoring method also includes associating the healthcare provider identification data and the usage data to provide a record of hygienic compliance for the healthcare provider.

### BACKGROUND OF THE INVENTION

The subject matter disclosed herein relates generally to healthcare providers, and, more particularly, to a healthcare provider hygiene compliance monitoring system and method.

Healthcare facilities, such as hospitals and clinics, provide clean and sterile environments in which patients may stay variable lengths of time, for hours to days or weeks. Throughout such stays, efforts are made to maintain a high level of cleanliness and hygiene appropriate with high quality care. However, some patients become infected while being cared for in healthcare facilities. It is evident that hospital infections and related complications may be a burden to patients, physicians, and the healthcare system. Studies have shown that by following proper hygiene procedures, the occurrence of infections and their related complications may be controlled or at least significantly reduced.

Therefore, to help prevent infections, most healthcare facilities have created hygiene guidelines, procedures, and policies. Unfortunately, some healthcare providers, such as doctors, nurses, or assistants, do not follow the facility procedures. Thus, infections and unnecessary illness may occur as a result. One such common hygiene procedure, and perhaps one of the most important, is hand washing. Often healthcare providers have been fully trained on when and how to properly wash their hands, but they may forget or otherwise fail to properly wash. Accordingly, it may be helpful for a healthcare facility to monitor which healthcare providers use proper hygiene in order to increase compliance with the procedures.

### BRIEF DESCRIPTION OF THE INVENTION

In one embodiment, a method for monitoring hygienic compliance in a medical institution includes detecting presence of a healthcare provider in a patient area and identifying the healthcare provider to produce provider identification data.

The monitoring method also includes detecting usage of a cleansing medium by the healthcare provider to produce usage data. The method includes transmitting the healthcare provider identification data and the usage data to an institutional information system. The monitoring method also includes associating the healthcare provider identification data and the usage data to provide a record of hygienic compliance for the healthcare provider.

In another embodiment, a system for monitoring hygienic compliance in a medical institution includes a presence sensor configured to detect presence of a healthcare provider in a patient area and to produce provider identification data. The system also includes a usage sensor configured to detect usage of a cleansing medium by the healthcare provider and to produce usage data. The system includes a network receiver configured to receive the provider identification data and the usage data and to transmit the healthcare provider identification data and the usage data to an institutional information system. The system also includes a data processing system configured to associate the healthcare provider identification data and the usage data to provide a record of hygienic compliance for the healthcare provider.

In a further embodiment, a system for monitoring hygienic compliance includes a presence sensor configured to detect presence of an individual in a compliance area and to produce identification data. The system also includes a usage sensor configured to detect usage of a cleansing medium by the individual and to produce usage data. The usage sensor includes one or more sensors disposed in the cleansing medium. The system includes a compliance area network configured to receive the identification data and the usage data and to transmit the identification data and the usage data to an institutional information system. The system also includes a data processing system configured to associate the identification data and the usage data to provide a record of hygienic compliance.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a healthcare provider hygiene compliance monitoring system in accordance with aspects of the present disclosure;

FIG. 2 is a block diagram of a healthcare provider hygiene compliance monitoring system with sensors transmitting directly to network receivers;

FIG. 3 is a block diagram of a healthcare provider hygiene compliance monitoring system with a dispenser sensor;

FIG. 4 is a block diagram of a healthcare provider hygiene compliance monitoring system with a proximity sensor; and

FIG. 5 is a flow chart of a method for monitoring healthcare provider hygiene compliance in a medical institution.

### DETAILED DESCRIPTION OF THE INVENTION

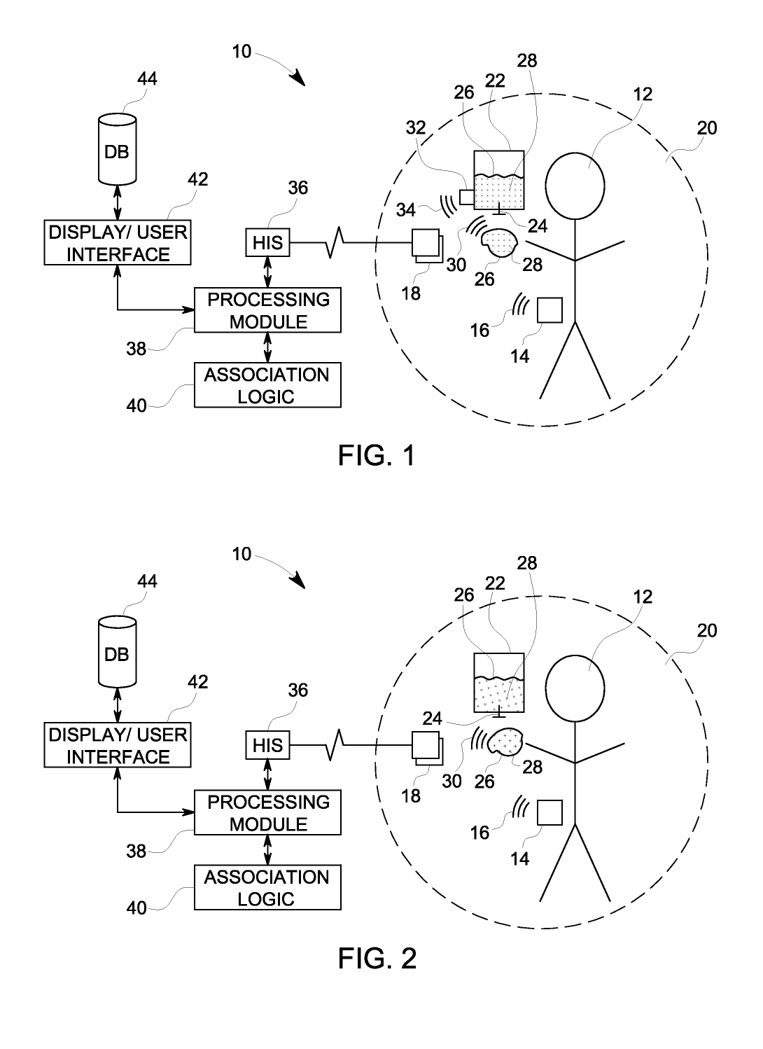

FIG. 1 is a block diagram of a healthcare provider hygiene compliance monitoring system 10. An individual, such as a healthcare provider 12, may wear an identification device 14 that produces provider identification data. The identification device 14 may be an identification tag or another type of electronic device. The identification device 14 may transmit a signal 16 that includes the provider identification data to network receivers 18. The signal 16 may be transmitted via RF, infrared, Wi-Fi, ZigBee, or any known or later developed data transmission technique. In addition, the identification device 14 may contain a code or other identifying device that can be scanned to record which device 14 is assigned to the healthcare provider 12. In one embodiment, a serial number or unique code on the identification device 14 may be manually entered into a record containing which device 14 is assigned to the provider 12.

As illustrated, one or more network receivers 18 may be used to receive data. With multiple receivers 18, one receiver may be configured to receive radiofrequency signals, while other receivers may be configured to receive infrared, ZigBee, Wi-Fi, Ethernet, or another type of signal. Furthermore, a reception range 20 of the network receivers 18 is depicted. As should be appreciated, the network receivers 18 may only receive signals from devices if the signal transmissions originate within the particular reception range 20. The size of the reception range 20 may vary depending on the type of protocol or transmission being used by the transmitter.

The network receivers 18 may receive the signal 16 including identification data from the identification device 14. The identification data may include information to track the presence and location of the healthcare provider 12 including tracking when the healthcare provider 12 enters a room with a patient. The receivers 18 may also track the location of the healthcare provider 12 within the room and the duration of time that the provider 12 spends at particular locations within the room, such as at a hand washing station. Furthermore, the receivers 18 may receive data from other devices that provide information relating to the healthcare provider 12 activity with respect to the patient. For example, the receivers 18 may receive activity data when the healthcare provider 12 uses a handheld device in a patient area, provides keyboard or other computer input, or uses any other device or method that can be tracked and would normally be used by the healthcare provider 12. Alternatively, if such activity is of interest, indications of the activity may be obtained by any reports, check-in or other input that the healthcare provider may make when in the room. As discussed below, such activity may be indicative of a particular need to follow hygiene procedures, particularly when they involve touching or handling the patient (as opposed, for example, to simply observing the patient status from a distance).

A dispenser 22 with a pumping section 24 may be located in the patient area, or another compliance area. The dispenser 22 contains a cleansing medium 26 that may be used by the healthcare provider 12 for hand washing or cleaning. In one presently contemplated embodiment, the cleansing medium 26 contains sensors 28 located within the cleansing medium 26 that may be activated to produce usage data. The sensors 28 may be minute pressure sensitive devices that transmit the usage data when pressure is applied to them. Furthermore, the sensors 28 may be manufactured using nanotechnology to enable the sensors to be extremely small. In one embodiment, the cleansing medium 26 may contain bacteria detection sensors that transmit a signal when they detect or come in contact with bacteria. Such sensors may be quite simple, and may simply emit a signal that is detectable, and used binarily to indicate usage (i.e., the presence of a signal versus no signal), rather than more complex encoded data.

The healthcare provider 12 may operate the dispenser pump 24 to cause the cleansing medium 26 to exit the dispenser 22. The healthcare provider 12 may then use the cleansing medium 26 to wash or clean their hands. The sensors 28 emit signals 30 including the usage data. For example, as the provider 12 applies pressure to the cleansing medium 26 including the sensors 28, the sensors may emit signals indicating that pressure has been applied. As should be appreciated, in one embodiment the sensors 28 may emit signals only when pressure is applied. Conversely, in another embodiment the sensors 28 may always emit signals, but the content of the signals 30 may change when pressure is applied.

A sensor receiver 32 may receive the signals 30 including the usage data from the sensors 28. Then, the sensor receiver 32 may transmit signals 34 including the usage data to the network receivers 18. It should be understood that because of their size in certain embodiments, the sensors 28 may be limited to transmitting signals over short distances. Therefore, the sensor receiver 32 may be located near the dispenser 22, which is also likely near where the healthcare provider 12 will wash or clean their hands. Thus, the sensor receiver 32 may be located close enough to the healthcare provider 12 hand washing area to receive the signals 30 from the sensors 28.

The network receivers 18 receive the identification data and the usage data, and send the data to an institution information system, such as a hospital information system 36. The hospital information system 36 coordinates the processing and storing of the healthcare provider data. The hospital information system 36 may include a processing module 38 for processing provider data. The processing module 38 receives the data and performs processing functions, which may include simple or detailed analysis of the data. Furthermore, the processing module 38 may use association logic 40 to interpret electronic signals that associate the usage data with the provider identification data in order to create an electronic hygienic compliance record. The data may be associated by correlating information such as the date, time, and location that the usage data and the identification data were received by the hospital information system 36. Likewise, healthcare provider activity may be associated with the usage data and the provider identification data using date, time, and location. The healthcare provider activities with respect to a patient in a patient area may also be included in the electronic hygienic compliance record.

A display/user interface 42 permits the data to be manipulated, viewed, and output in a user-desired format, such as in traces on screen displays, hardcopy, and so forth. The processing module 38 may also mark or analyze the data for marking such that annotations, delimiting or labeling axes or arrows, and other indicia may appear on the output produced by interface 42. Finally, a database 44 serves to store the electronic hygienic compliance records either locally within the resource, or remotely. The database 44 may also permit reformatting or reconstruction of the data, compression of the data, decompression of the data, and so forth.

FIG. 2 is a block diagram of a healthcare provider hygiene compliance monitoring system 10 with sensors 28 transmitting directly to network receivers 18. As previously described, the healthcare provider 12 may have the identification device 14 which transmits the signal 16 to the network receivers 18. The healthcare provider 12 may use the dispenser pump 24 to dispense the cleansing medium 26 containing the sensors 28. The provider 12 may then wash or clean their hands, and when the sensors 28 are activated they emit signals 30 containing usage data. However, in this embodiment, the sensors 28 may transmit the signal 30 directly to the network receivers 18, without the use of an intermediary sensor receiver. This direct transmission may be possible with sensors 28 that have a sufficiently long transmission range, or by placing the network receivers 18 close enough to the hand washing area, for example.

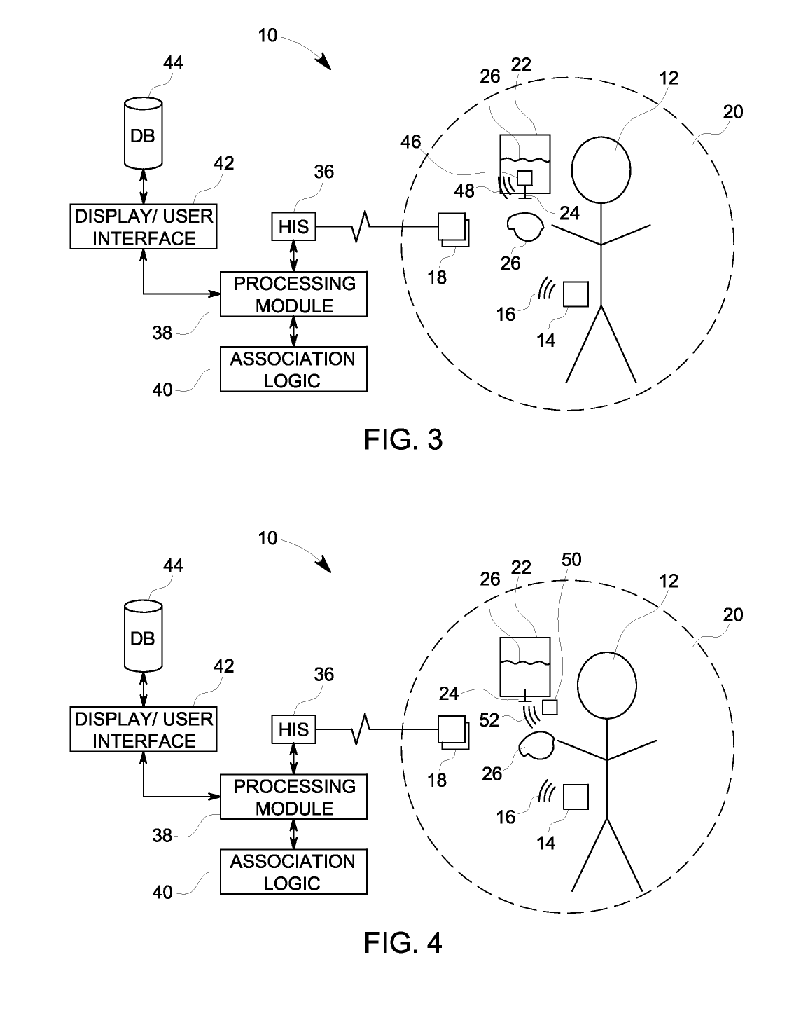

FIG. 3 is a block diagram of a healthcare provider hygiene compliance monitoring system 10 with a dispenser sensor. This system 10 includes the identification device 14 worn by the healthcare provider 12 and used to generate provider identification data. The system 10 also includes the dispenser 22 with the cleansing medium 26. Herein, the dispenser 22 includes a dispenser sensor 46 that is used to detect when the cleansing medium 26 leaves the dispenser 22. For example, the dispenser sensor 46 may be located within the pump 24 such that when the pump moves the cleansing medium 26, the sensor 46 detects the movement and/or the quantity of cleansing medium 26 pumped.

The dispenser sensor 46 transmits usage data via signal 48 to the network receivers 18. The data is then sent to the hospital information system 36 where processing and storing may occur. For example, the association logic 40 may receive the usage data and the provider identification data and associate the data together using information such as the date, time, and location to correlate when and where the data was received. This associated data may then be stored in a compliance record.

FIG. 4 is a block diagram of a healthcare provider hygiene compliance monitoring system 10 with a proximity sensor. Again, the healthcare provider 12 may wear the identification device 14. In this embodiment, a proximity sensor 50 produces usage data to monitor hygiene compliance. The proximity sensor 50 may be located near the dispenser 22. In such a location, the proximity sensor 50 may detect how close an object is to the sensor 50. For example, the sensor 50 may detect an object such as a hand moving toward the dispenser 22, including detecting the distance of the hand from the sensor 50. Likewise, the sensor 50 may detect movement of a hand such as the back and forth movement that may be used to operate the pump 24 on the dispenser 22. Furthermore, the sensor 50 may also detect a location of an object relative to the sensor 50. Thereafter, the sensor 50 may transmit signals 52 that contain the usage data to the network receivers 18. Within the hospital information system 36, the usage data may be combined with the identification data and stored in a hygiene compliance record.

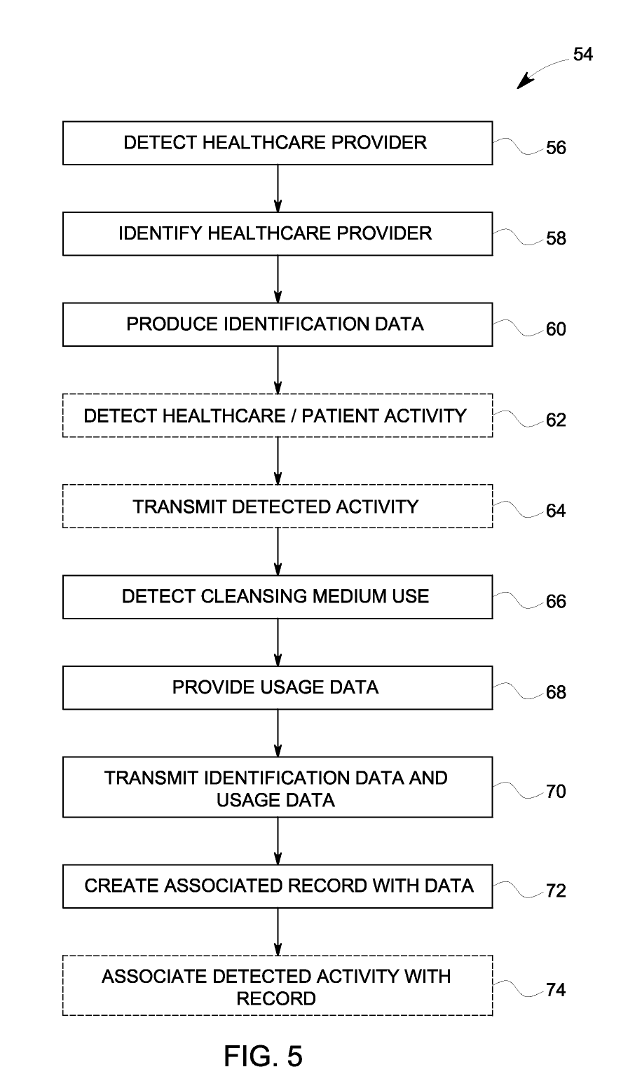

FIG. 5 is a flow chart of a method for monitoring healthcare provider hygiene compliance 54 in a medical institution. It should be noted that the steps described below may be completed in any appropriate order. Likewise, some steps described are optional, while other steps may be added.

At step 56, the presence of a healthcare provider in a patient area is detected. The presence of the provider may be detected in any manner, such as receiving a transmission signal from a healthcare provider identification device, or detecting a provider identification device within the patient area. Next at step 58, the healthcare provider is identified using data from the identification device. For example, the provider identification device may transmit a code that corresponds to a code in a provider identification record. Then at step 60, provider identification data is produced to form the provider identification record.

At step 62, activity of the healthcare provider with respect to a patient in the patient area may be detected. As previously described, the activity may be normal activities performed by the healthcare provider, such as logging onto a computer, using tracked devices, and entering a room, among others. Next at step 64, the detected activity may be transmitted to a network receiver.

At step 66, usage of a cleansing medium by the healthcare provider may be detected. For example, sensors within the cleansing medium may be activated when used, a sensor within a dispenser may detect dispensed cleansing medium, or a proximity sensor may detect the healthcare provider in the proximity of the dispenser. Next at step 68, the sensors may produce usage data, such as signals indicating that pressure has been applied to the sensors or other data indicative of cleansing medium usage. Then at step 70, the provider identification data and the usage data may be transmitted to an institutional information system, such as the hospital information system.

At step 72, the provider identification data is associated with the usage data to provide a record of hygienic compliance for the healthcare provider. The identification data may be associated with the usage data by comparing the date, time, and location of when and where the data was received, for example. Next at step 74, the detected healthcare provider activity may be associated with the record of hygienic compliance. Like other data association steps, the activity data may be associated with the usage and identification data using date, time, and location information received from the sensors and/or devices or recorded when the data was received.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for monitoring hygienic compliance in a medical institution, comprising:
detecting presence of a healthcare provider in a patient area and identifying the healthcare provider to produce provider identification data;
detecting usage of a cleansing medium by the healthcare provider to produce usage data;
transmitting the healthcare provider identification data and the usage data to an institutional information system; and
associating the healthcare provider identification data and the usage data to provide a record of hygienic compliance for the healthcare provider.

2. The method of claim 1, further comprising detecting activity of the healthcare provider with respect to a patient in the patient area, and transmitting activity data representative of the detected activity.

3. The method of claim 2, comprising associating the activity data with the hygienic compliance record.

4. The method of claim 1, wherein the usage data is produced by one or more sensors disposed in the cleansing medium.

5. The method of claim 4, wherein the one or more sensors comprise a pressure sensitive transmitter.

6. The method of claim 1, wherein the usage data is produced by one or more sensors disposed in a dispenser of the cleansing medium.

7. The method of claim 1, wherein the usage data is produced by one or more sensors disposed in proximity to a dispenser of the cleansing medium.

8. A system for monitoring hygienic compliance in a medical institution, comprising:
a presence sensor configured to detect presence of a healthcare provider in a patient area and to produce provider identification data;
a usage sensor configured to detect usage of a cleansing medium by the healthcare provider and to produce usage data;
a network receiver configured to receive the provider identification data and the usage data and to transmit the healthcare provider identification data and the usage data to an institutional information system; and
a data processing system configured to associate the healthcare provider identification data and the usage data to provide a record of hygienic compliance for the healthcare provider.

9. The system of claim 8, wherein the presence sensor comprises a radiofrequency reader that detects a radiofrequency signal emitted by a tag associated with the healthcare provider.

10. The system of claim 8, wherein the presence sensor comprises an infrared reader that detects an infrared signal emitted by a tag associated with the healthcare provider.

11. The system of claim 8, further comprising an activity monitor configured to detect activity of the healthcare provider with respect to a patient in the patient area, and transmitting activity data representative of the detected activity.

12. The system of claim 11, wherein the data processing system is configured to associate the activity data with the hygienic compliance record.

13. The system of claim 8, wherein the usage sensor comprises one or more sensors disposed in the cleansing medium.

14. The system of claim 13, wherein the one or more sensors comprise a pressure sensitive transmitter.

15. The system of claim 8, wherein the usage sensor comprises one or more sensors disposed in a dispenser of the cleansing medium.

16. The system of claim 8, wherein the usage sensor comprises one or more sensors disposed in proximity to a dispenser of the cleansing medium.

17. A system for monitoring hygienic compliance, comprising:
a presence sensor configured to detect presence of an individual in a compliance area and to produce identification data;
a usage sensor configured to detect usage of a cleansing medium by the individual and to produce usage data, wherein the usage sensor comprises one or more sensors disposed in the cleansing medium;
a network receiver configured to receive the identification data and the usage data and to transmit the identification data and the usage data to an institutional information system; and
a data processing system configured to associate the identification data and the usage data to provide a record of hygienic compliance.

18. The system of claim 17, wherein the presence sensor comprises a radiofrequency reader that detects a radiofrequency signal emitted by a tag associated with the individual.

19. The system of claim 17, wherein the presence sensor comprises an infrared reader that detects an infrared signal emitted by a tag associated with the individual.

20. The system of claim 17, wherein the one or more sensors comprise a pressure sensitive transmitter.
